(19) United States
(12) Patent Application Publication
(10) Pub. No.: US 2026/0259953 A1
(43) Pub. Date: Sep. 3, 2026

(54) TRANSFORMED ACTIVATION FUNCTION WITH ISA EXTENSION

(71) Applicant: Akeana, Inc., Santa Clara, CA (US)

(72) Inventors: Hing Yin Lai, San Jose, CA (US); Albert Anthony Martin, Sunnyvale, CA (US); Rabin Sugumar, Sunnyvale, CA (US)

(73) Assignee: Akeana, Inc., Santa Clara, CA (US)

(21) Appl. No.: 19/551,690

(22) Filed: Feb. 27, 2026

Related U.S. Application Data
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.
(60) Provisional application No. 63/941,793, filed on Dec. 16, 2025.
(60) Provisional application No. 63/983,964, filed on Feb. 16, 2026.

(51) Int. Cl. G06F 17/16; G06N 3/048

(52) U.S. Cl. CPC G06F 17/16; G06N 3/048

(57) ABSTRACT

A binary output is assigned, in a lookup table (LUT), to each binary input within a plurality of binary inputs. The assigning is based on a core activation function. The LUT is transformed. The transforming results in a plurality of combinational logical functions. The transforming includes interpolating linearly one or more combinational logic functions associated with each input bit within the plurality of binary inputs. Each combinational logical function corresponds to a unique output bit of the core activation function. An instruction set architecture (ISA) is augmented. The augmenting includes a custom instruction. The custom instruction is based on the plurality of combinational logical functions. One or more activation functions within a machine learning model are executed. The executing is based on the custom instruction. The executing includes accessing a corresponding combinational logic function within the plurality of combinational logic functions.

### RELATED APPLICATIONS

This application claims the benefit of U.S. provisional patent applications “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, “Hierarchical Performance-Based Scheduler For Data Center Workloads” Ser. No. 63/941,793, filed Dec. 16, 2025, and “Memory Latency Hiding With A Memory Accelerator” Ser. No. 63/983,964, filed Feb. 16, 2026.

Each of the foregoing applications is hereby incorporated by reference in its entirety.

### FIELD OF ART

This application relates generally to matrix processing and more particularly to transformed activation function with ISA extension.

### BACKGROUND

Since the invention of number systems thousands of years ago, humans have sought ways to manipulate numbers. Numbers have been used for tallying, quantifying and describing items based on weights and measures, calculating ratios and areas, and many other purposes. As humans adopted trade, the need to quantify goods provided and payments received became essential. Goods sold by weight, quantity, and so on required payment of an appropriate amount of money or other goods. Keeping track of goods sold and payments received enabled markets and economies to flourish. Numbers also played key roles in constructing buildings, bridges, roads, and other structures. Architectural features, such as arches formed for windows and bridge supports, were built based on mathematical formulas. An arch built based on a catenary form was strong and reliable. With a carefully placed keystone at the top, a catenary arch could hold together simply due to the weight of the materials that form it.

Humans developed techniques, tools, and eventually devices to manipulate numbers. Simple number manipulation techniques included addition, subtraction, multiplication, and division. Tools used for manipulating numbers varied widely. Wooden sticks and pebbles were used for performing addition and subtraction. Cowry shells were used for addition and subtraction as well as for money. And the abacus, in use in China, the Near East, Russia, and Europe, provided a more convenient device for performing calculations. Simple number manipulation devices evolved into calculating devices. These latter devices included Leibnitz' stepped reckoner which used a stepped drum to perform all four basic arithmetic operations. The Difference Engine, which could tabulate polynomial functions, and the Analytical Engine, which is considered the first general-purpose computer, were mechanical devices designed and at least partially built by Babbage in the 1820s and 1830s. Device technology continued to evolve through the 20^{th} Century and into the 21^{st} Century with the invention of electronic computers, calculators, and other devices.

Today, numeric manipulation, including numeric manipulation of complex data structures such a matrix manipulation, is performed using processors based on integrated circuits (ICs). These processors include hardware that is designed to perform a wide range of numeric manipulations. The processors are configured by programming or coding them. The code, which is based on an instruction set, includes instructions for loading data, manipulating data, and storing data. The processors and their associated instruction sets typically fall into two general category types: Complex Instruction Set Computer (CISC) types and Reduced Instruction Set Computer (RISC) types. In a CISC processor, one instruction may execute several operations. The operations can include storing to and reading from memory, arithmetic and logical operations, and so on. In contrast, in a RISC processor, the instruction sets tend to be smaller than the instruction sets of CISC processors. Instructions may be executed in a pipelined manner using pipeline stages that may include fetch, decode, and execute. Each of these pipeline stages may take one clock cycle to complete. Thus, the pipelined operation can allow RISC processors to operate on more than one instruction per clock cycle.

### SUMMARY

Engineers and designers have traditionally come under pressure to deliver more performance with each new processor. The advance of machine learning networks have accelerated this demand for performance. Today, networks such as neural networks are finding uses in many different applications such as ecommerce, social media, video, finance, self-driving cars, and so on. Traditional means of computing are no longer effective in meeting these demands. AI processors, accelerators, units within a processor, etc. have been developed to meet the need of running neural networks, some of which can be quite large. One bottleneck that remains in the execution of these models is the computation of activation functions for each node of the network.

Disclosed techniques enable matrix processing. A binary output is assigned, in a lookup table (LUT), to each binary input within a plurality of binary inputs. The assigning is based on a core activation function. The LUT is transformed. The transforming results in a plurality of combinational logical functions. The transforming includes interpolating linearly one or more combinational logic functions associated with each input bit within the plurality of binary inputs. Each combinational logical function corresponds to a unique output bit of the core activation function. An instruction set architecture (ISA) is augmented. The augmenting includes a custom instruction. The custom instruction is based on the plurality of combinational logical functions. One or more activation functions within a machine learning model are executed. The executing is based on the custom instruction.

A processor-implemented method for matrix processing is disclosed comprising: assigning, in a lookup table (LUT), to each binary input within a plurality of binary inputs, a binary output, wherein the assigning is based on a core activation function; transforming the LUT, wherein the transforming results in a plurality of combinational logical functions, wherein each combinational logical function within the plurality of combinational logical functions corresponds to a unique output bit of the core activation function; augmenting an instruction set architecture (ISA), wherein the augmenting includes a custom instruction, wherein the custom instruction is based on the plurality of combinational logical functions; and executing one or more activation functions within a machine learning model, wherein the executing is based on the custom instruction. In embodiments, the executing includes accessing, for every output bit of an activation function within the machine learning model, a corresponding combinational logic function within the plurality of combinational logic functions. In embodiments, the custom instruction comprises a custom vector instruction.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for an activation function accelerator with custom ISA instructions.

FIG. 2 is a flow diagram for transforming outputs.

FIG. 3 is an example node calculation within a neural network.

FIG. 4 is an example FP16 format number.

FIG. 5 is a sigmoid lookup table example.

FIG. 6 is an example of creating Sigmoid combinational logic functions.

FIG. 7 is an example of accelerating a tanh activation function.

FIG. 8 is a block diagram of a multicore processor.

FIG. 9 is a block diagram of a pipeline.

FIG. 10 is a system diagram for activation function execution with custom ISA instructions.

### DETAILED DESCRIPTION

The race to accelerate artificial intelligence is on. Many processors now include an artificial intelligence (AI) accelerator unit which can accelerate the implementation of a machine learning model such as a neural network, convolutional neural network, transformer, large language model (LLM), and so on. Dedicated hardware acceleration, sometimes comprising many cores across many chips, boards, racks, and data centers, is available to further speed up these functions. However, many bottlenecks remain. For example, when executing a large machine learning model, bandwidth can be a performance limitation, especially when sending large amounts of data between AI accelerators.

Another performance limitation can be found in the way each node within a machine learning model is calculated. An activation function can be used to determine whether a node within a machine learning network should be activated during execution. The activation function can further determine the output of a node based on a sum of the weighted inputs (e.g., sum of products) to the node. The activation function can be based on a variety of functions such as tanh, sigmoid, ReLU, softmax, and so on. These functions can be time consuming for a processor to calculate. Often, these functions are calculated through the use of a library call to a machine learning library such as PyTorch. However, these calls can also be inefficient, wasting valuable processing time. The problem is compounded many times as larger machine learning models can comprise millions or billions of nodes, each requiring the calculation of an activation function, resulting in a significant performance bottleneck.

Disclosed techniques enable matrix processing. A binary output is assigned, in a lookup table (LUT), to each binary input within a plurality of binary inputs. The assigning is based on a core activation function. The LUT is transformed. The transforming results in a plurality of combinational logical functions. The transforming includes interpolating linearly one or more combinational logic functions associated with each input bit within the plurality of binary inputs. Each combinational logical function corresponds to a unique output bit of the core activation function. An instruction set architecture (ISA) is augmented. The augmenting includes a custom instruction. The custom instruction is based on the plurality of combinational logical functions. One or more activation functions within a machine learning model is executed. The executing is based on the custom instruction.

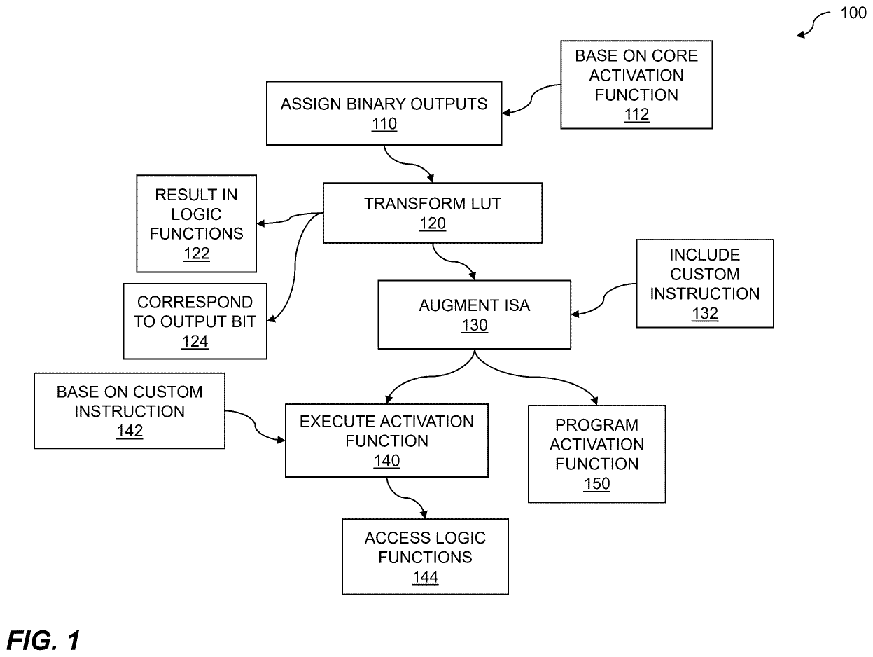

FIG. 1 is a flow diagram for an activation function accelerator with custom ISA instructions. The flow 100 includes assigning 110, in a lookup table (LUT), to each binary input within a plurality of binary inputs, a binary output. The LUT can be stored during the assigning, during use, and so on. The memory hierarchy can be coherent or non-coherent. The assigning a binary output to each binary input within the plurality of binary inputs can be based on an algorithm, a heuristic, a function, and so on. In embodiments, each binary input within the plurality of binary inputs comprises a floating-point 16 (FP16) format number. While the half-precision FP16 format is mentioned, other floating-point representations such as sign-precision FP32, double-precision FP64, and so on, can also be used. In embodiments, the plurality of binary inputs comprises all possible values of the FP16 format number. The possible decimal values for FP16 can range from −65,504 to +65,504.

In the flow 100, the assigning is based on a core activation function 112. The machine learning model can include one or more activation functions. A machine learning model can include an activation function as part of each node. An activation function can be used to determine whether a node within a network, such as a network configured for machine learning, should be activated during the execution of the machine learning model. The activation function can further determine the output of a node based on a sum of the weighted inputs (e.g., sum of products) to the node. The activation function can be based on the core activation function, which can comprise a variety of functions integral to the activation function. For example, for a machine learning network, an activation function can comprise a hyperbolic tangent (tanh) function. However, the calculation of the tanh function can include a sigmoid function. In embodiments, the core activation function is based on a sigmoid function. The sigmoid function can map negative values to zero and can map positive values to a range between zero and one. In other embodiments, the core activation function is based on an exponential function (EXP). An exponential activation function can produce positive outputs for positive inputs, and negative outputs for negative inputs. In further embodiments, the core activation function and the one or more activation functions comprise a Gaussian Cumulative Distribution Function (GELU). A machine learning network can include many different activation functions. For any single node, the core activation function and the activation function can comprise a Gaussian Cumulative Distribution Function (GELU). The output of the GELU activation function can be calculated based on the cumulative distribution function of a standard Gaussian distribution.

The flow 100 includes transforming 120 the LUT. The transforming can be accomplished using an application, a program, a compiler, etc. A compiler can include a general-purpose compiler such as a C compiler, a Python compiler, and so on. The compiler can include a hardware design compiler such as a VHDL compiler, a Verilog compiler, and the like. In the flow 100, the transforming results in a plurality of combinational logical functions 122. The combinational logical functions can include Boolean logic functions. The Boolean logic functions can include one or more of AND, OR, NAND, NOR, XOR, XNOR, NOT, and so on. The Boolean logic functions can include functions in human-readable form, functions in machine-readable form, etc. In the flow 100, each combinational logical function within the plurality of combinational logical functions corresponds to a unique output bit 124 of the core activation function. A value of the unique output bit can be determined by each combinational logical function. The value of the unique output bit depends only on values associated with current inputs to each combinational logical function. That is, no state nor memory need be associated with each combinational logical function.

The flow 100 includes augmenting 130 an instruction set architecture (ISA). The ISA can be associated with a particular processor architecture. In embodiments, the ISA comprises a RISC-V® ISA. As described throughout, an activation function associated with one or more nodes of an AI model can require a significant number of processor cycles, resulting in a delay in producing the activation function. This delay in calculating the activation function can result in a performance loss. The augmenting includes a custom vector instruction 132. Activation functions can require different functions to be executed. These can include core activation functions, such as described above. In embodiments, the custom instruction comprises a custom vector instruction. Some processors further include hardware and instructions for computing more complex operations such as vector operations. Thus, a custom instruction that can utilize ALU and vector operations, for example, can achieve performance increases. The custom vector instruction can be associated with a core activation function which can form the basis of executing one or more activation functions within a machine learning network. In a usage example, the custom vector instruction can be associated with a RISC-V® ISA. The custom vector instruction can access state variables, status information, and so on associated with the RISC-V® ISA. In embodiments, the custom instruction is based on one or more RISC-V® vector state variables and can be based on vector instructions within the RISC-V® instruction set. In embodiments, the custom vector instruction comprises a vsig instruction. The vsig instruction can execute a sigmoid operation, as part of an activation function of a machine learning network. The vsig instruction can comprise a RISC-V® vector signal instruction group instruction. The vsig instruction can be designed to execute vector operations on large data sets, thus allowing for multiple core activation functions to be calculated in parallel. In some embodiments, the custom vector instruction comprises a vexp instruction. The vexp instruction can be useful for computing activation functions that incorporate an exponential operation. In other embodiments, the one or more activation functions comprise an Exponential Linear Unit (ELU). The ELU can directly output an input value when the input value is positive. The ELU can utilize an exponential function to produce negative output values when the input value is negative. Other versions of an ELU can be used. In embodiments, the one or more activation functions comprise a Scaled Exponential Linear Unit (SELU). The custom instruction is based on the plurality of combinational logical functions. As described above, a LUT can be transformed into a plurality of combinational logical functions. Each logical function can be associated with an output of the core activation function associated with the custom instruction. The custom instruction, when executed by the processor core, can access each of the logical functions to generate each output of the core activation function.

The flow 100 includes executing 140 one or more activation functions within a machine learning model. As described above and throughout, a machine learning model can include an activation function as part of each node, which can be used to determine whether each node within a network should be activated during the execution of the machine learning model. The activation function can further determine the output of a node based on a sum of the weighted inputs (e.g., sum of products) to the node. A machine learning model can include any number of nodes and therefore any number of activation functions.

The executing can be based on the custom instruction 142. The core activation function associated with the custom instruction can comprise a variety of functions integral to any activation function within the machine learning model. For example, for a machine learning network, an activation function can comprise a hyperbolic tangent (tanh) function. However, the calculation of the tanh function can include a sigmoid function. In embodiments, the core activation function is based on a sigmoid function. The sigmoid function can map negative values to zero and can map positive values to a range between zero and one. In other embodiments, the core activation function is based on an exponential function (EXP). An exponential activation function can produce positive outputs for positive inputs, and negative outputs for negative inputs. In further embodiments, the core activation function and the one or more activation functions comprise a Gaussian Cumulative Distribution Function (GELU). A machine learning network can include many different activation functions. For any single node, the core activation function and the activation function can comprise a Gaussian Cumulative Distribution Function (GELU). The output of the GELU activation function can be calculated based on the cumulative distribution function of a standard Gaussian distribution.

The custom instruction can be executed on a processor with an architecture associated with the ISA for which the custom instruction was created, such as RISC-V® as described above. In a usage example, the custom instruction is executed on a processor which executes RISC-V® instructions. In the flow 100, the executing includes accessing 144, for every output bit of an activation function within the machine learning model, a corresponding combinational logic function within the plurality of combinational logic functions. The combinational logic functions can be executed using an ALU, a vector unit, a pipeline, and so on associated with the processor. The combinational logic functions can be based on one or more custom instruction operations. In a usage example, an activation instruction comprises a tanh function. The tanh function can be calculated according to the following equation:

$$tan h ( x ) = 2 ( sigmoid ( 2 x ) - 1 ) \qquad Equation 1$$

A core activation function can comprise a sigmoid function which can be implemented by disclosed techniques in a custom RISC-V® instruction such as a vsig instruction. Executing the vsig instruction can require four vector cycles within the processor core. The final tanh activation function can then be completed with additional RISC-V® instructions. Alternatively, the tanh can be calculated with a function call to a library, such as a PyTorch library, to determine the sigmoid component of the tanh activation function in equation 1. This can require many ALU cycles, lowering overall performance in executing the machine learning model.

The flow 100 further includes programming 150 the activation function for the machine learning model, wherein the programming includes the vsig instruction. The programming can be based on one standard programming language such as C, Python, R, Assembly, and so on. The programming can be compiled to add the vsig function. The programming can be based on a hardware description language (HDL) such as VHDL, Verilog, and the like. In embodiments, the programming includes one or more additional ISA instructions, wherein the one or more additional ISA instructions complete the one or more activation functions. The additional ISA instructions can include additional vsig instructions or other instructions. The activation function that is programmed can be based on one or more functions. In embodiments, the one or more activation functions comprise a hyperbolic tangent (tanh) function. The tanh function can receive positive inputs and negative inputs, and can generate positive outputs and negative outputs, respectively. In other embodiments, the one or more activation functions comprises a sigmoid linear unit function (SILU). The SILU, which can also be referred to as a “Swish” activation function, can be calculated by multiplying an input value by a result of applying the sigmoid function to the input value. In further embodiments, the one or more activation functions comprise a Swish Gated Linear Unit function (SwiGLU). The SwiGLU can be computed by combining a SILU activation function with a Gated Linear Unit (GLU). The GLU can enable control of data through a neural network by selectively permitting or “gating” relevant data to flow through a neural network while filtering out irrelevant data.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

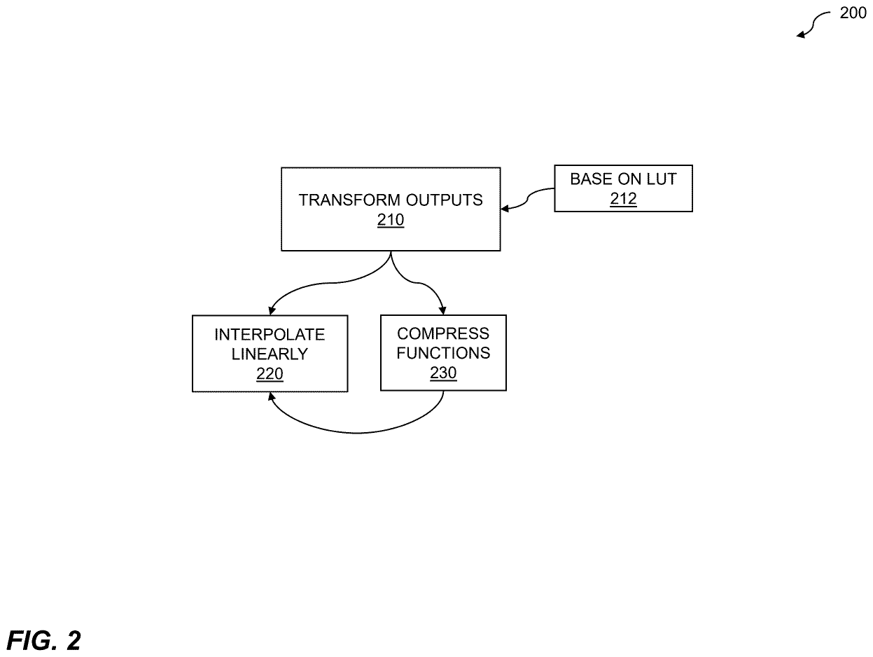

FIG. 2 is a flow diagram for transforming outputs. A binary output can be assigned, in a lookup table (LUT), to each binary input within a plurality of binary inputs. The assigning can be based on a function such as a function associated with a machine learning (ML) model. In embodiments, the assigning is based on a core activation function. The activation function can determine whether a node or neuron within a neural network should be activated during processing of a model such as the ML model. The activation function can transform a weighted sum of products associated with inputs to a neuron within the neural network. The output generated by the activation function can then be passed to one or more neurons in a subsequent layer of neurons within the neural network, passed to a neural network output, and so on. Since processing by the activation function of the weighted sum of products associated with the neuron can be computationally intensive, binary outputs assigned to the LUT can be transformed into combinational logical functions. The logical functions can be based on instructions native to a processor architecture and custom instructions that augment an instruction set architecture (ISA) associated with the processor. The transforming outputs enables a transformed activation function with an ISA extension.

A binary output is assigned, in a lookup table (LUT), to each binary input within a plurality of binary inputs. The assigning is based on a core activation function. The LUT is transformed. The transforming results in a plurality of combinational logical functions. Each combinational logical function within the plurality of combinational logical functions corresponds to a unique output bit of the core activation function. An instruction set architecture (ISA) is augmented. The augmenting includes a custom instruction which is based on the plurality of combinational logical functions. One or more activation functions within a machine learning model are executed, based on the custom instruction.

The flow 200 includes transforming outputs 210. The transforming results in a plurality of combinational logical functions. The combinational logic functions can include functions formed from basic logical operations such as AND, OR, NAND, NOR, XOR, XNOR, NOT, and so on. In the flow 200, the transforming is based on a lookup table (LUT) 212. The LUT includes one or more binary outputs. A binary output is assigned, in the lookup table, to each binary input within a plurality of binary inputs. The assigning is based on a core activation function. In a usage example, a list of decimal inputs can be made, which are associated with a FP16 number. The decimal range of the FP16 number can be −65,504 to +65,504. An output can be associated with each decimal input, based on an activation function such as the sigmoid function. The association can be made in a table. The table can be converted to a binary format. The transforming can then be performed on the table. For each binary output bit, logical functions can then be determined, which are a function of one or more of the input bits (some bits can comprise a “don't care” condition for any of the output bits). Each combinational logic function that results from the transforming can be associated with one or more bits such as output bits. In embodiments, each combinational logical function within the plurality of combinational logical functions corresponds to a unique output bit of the core activation function. The combinational logic functions can be executed in software, compiled into digital hardware, and so on. The core activation function can be based on a variety of functions suitable for machine learning and other applications. In embodiments, the core activation function is based on a sigmoid function. The core activation function can be based on other functions. In embodiments, the core activation function is based on an exponential function (EXP).

In the flow 200, the transforming includes interpolating linearly 220 one or more combinational logic functions within the plurality of combinational logic functions associated with each input bit within the plurality of binary inputs. Interpolation is a technique that can be used to determine an unknown value between two or more known values. The interpolation can include linear interpolation which is based on a line drawn between the two or more points. The interpolation can also be based on polynomial interpolation, nearest neighbor interpolation, and so on. A linear interpolation technique can be chosen because of its simpler computational complexity. The linear interpolation can be based on fitting a line to a number of points that includes two or more points. In embodiments, the interpolating linearly is based on a quantization of four. The quantization of four can result in reducing the size of the LUT table. With a quantization of four, only every fourth input is required in the LUT and associated with an output. Thus, not only is the LUT table size reduced, but the size of the logical functions can also be reduced to determine each output bit.

In the flow 200, the transforming includes compressing one or more combinational logic functions 230 within the plurality of combinational logic functions. Compressing a combinational logical function, such as a combinational logical function resulting from the transforming, can be performed in order to speed the combinational logical function. The compressing can be accomplished by identifying and eliminating redundancies in the logical function. The compressing can further include reducing the number of operations (e.g., logical operations) that occur within the logical function. The compressed logical functions can be stored as combinational logic cones (described below).

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

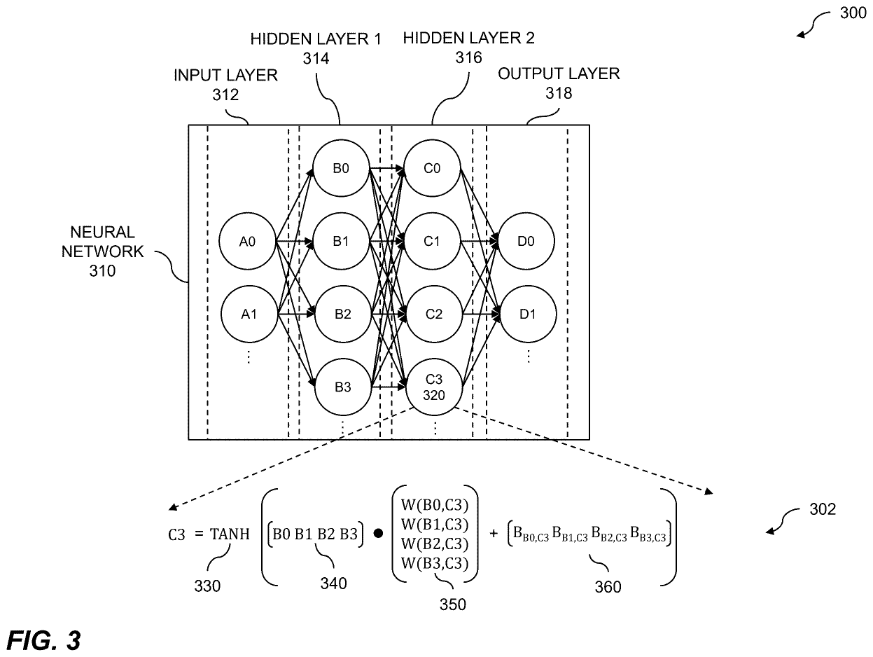

FIG. 3 is an example node calculation within a neural network. Discussed previously and throughout, a machine learning (ML) model can be executed on a network such as a neural network (NN). The neural network can include a convolutional neural network (CNN). The machine learning model can comprise any appropriate model such as an LLM, transformer, etc. The NN comprises layers of processing elements called neurons. A neuron can perform one or more computations, where the computations can include applying one or more weights to one or more input values provided to the neuron. The resulting product or products can be summed inputs (e.g., sums of products). The input values can include values generated by an activation function associated with a previous or “upstream” neuron, an input to the neural network, and so on. The neuron can apply an activation function to the sum of products to generate an output. The output of the neuron can be provided as an input to a neuron in a subsequent or “downstream” neuron, an output of the NN, and the like. The computations performed by the neuron can be based on a custom instruction added to an instruction set architecture (ISA). The node calculation is supported by a transformed activation function with an ISA extension.

In the example 300, node calculations are performed by nodes or neurons within a neural network (NN). An example NN 310 is shown. The NN includes one or more layers. In the example shown, the layers include an input layer 312, a first hidden layer, hidden layer 1 314, a second hidden layer, hidden layer 2 316, and an output layer 318. While two hidden layers are shown within the example, any number of hidden layers can be included within a neural network. Each layer can include one or more neurons. The neural network 310 includes two neurons, A0 and A1, in the input layer; four neurons, B0, B1, B2, and B3 in hidden layer 1; four neurons, C0, C1, C2, and C3 in hidden layer 2; and two neurons in the output layer, D0 and D1. The number of neurons on each hidden layer can be substantially similar or can be different. The number of neurons in a hidden layer can be equal to the sum of the number of neurons in the input layer and the number of neurons in the output layer. A neuron in a hidden layer can be coupled to one or more neurons in a previous or upstream layer. In the example shown, each node in a hidden layer is coupled to each node in a previous layer. This coupling technique is referred to as fully connected to the previous layer.

An example node calculation for node C3 320 is shown 302. The calculation performed by node C3 can include an activation function. One or more activation functions can be included in the neural network. A variety of functions can be used to calculate the activation function. In embodiments, the one or more activation functions comprise a hyperbolic tangent (tanh) function 330. Other functions can be chosen for the activation function. In embodiments, the other activation functions can be based on a sigmoid function, a sigmoid linear unit function (SILU), a Swish Gated Linear Unit function (SwiGLU), an Exponential Linear Unit (ELU), a Scaled Exponential Linear Unit (SELU), a Gaussian Cumulative Distribution Function (GELU), and so on. The activation function can be applied to a vector sum of a sum of products and a bias. Discussed above, the sum of products is computed by multiplying output from a previous layer by weights associated with the node. Since hidden layer 2 is fully connected to hidden layer 1, the inputs to C3 include the outputs of B0, B1, B2, and B3 as represented by vector 340. The weights associated with C3 include weights W (B0, C3), W (B1, C3), W (B2, C3), and W (B3, C3) as represented by vector 350. Biases can be added to the sum of products. The biases can include B_{B0,C3}, B_{B1,C3}, B_{B2,C3} and B_{B3,C3} represented by vector 360. The result of the node calculation by node C3 can be sent to the nodes D0 and D1 in the output layer.

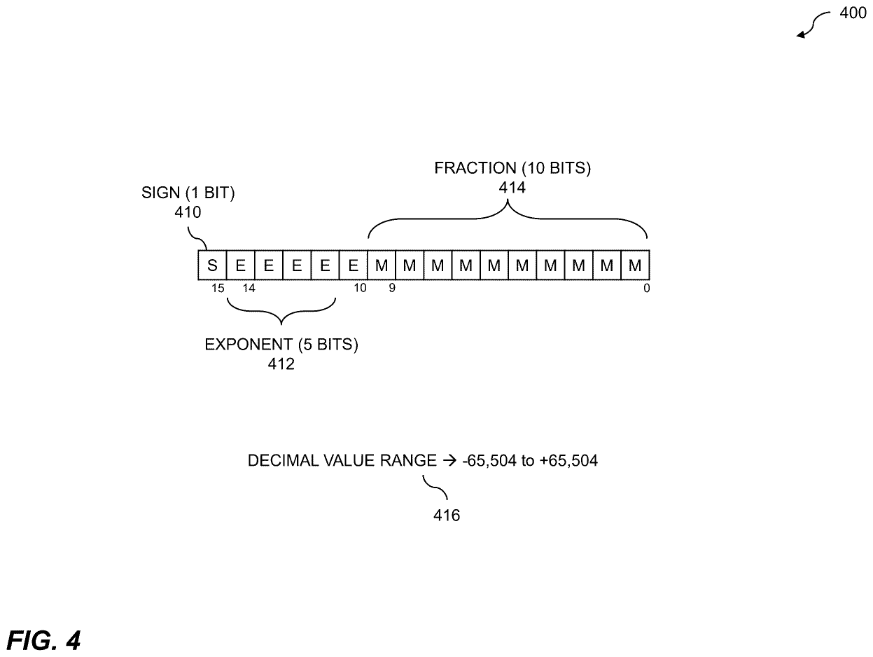

FIG. 4 is an example FP16 format number. Calculations performed by nodes within a network such as a neural network can be performed by each binary input within a plurality of binary inputs to the neural network. The binary inputs can be based on a number system representation. The computations performed by a node such as a node within the neural network can be performed on various data types such as audio data, image data, video data, natural language data, and so on. The data on which the computations are performed can have a wide dynamic range. In a usage example, input binary data on which the computations are performed can include image data. As a result of the wide dynamic range associated with the input data, an integer number system representation such as a signed integer or a real number system representation may not be sufficiently broad for the processing tasks. Instead, a floating-point representation is better suited to the processing task. The floating-point number system representations can include a half-precision representation (16-bit), a single-precision representation (32-bit), a double-precision representation (64-bit), and so on. In embodiments, each binary input within the plurality of binary inputs comprises a floating-point 16 (FP16) format number. The FP16 floating-point number representation supports computations associated with a transformed activation function with an ISA extension. Any floating-point representation can be used including FP64, FP32, FP8, BF16, BF16; microscaling formats such as MXFP8 and MXFP16; and so on.

The example 400 shows a floating-point 16 (FP16) representation. The FP16 representation is a “little endian” representation, where the least significant bit (LSB), bit 0 is at the right end of the FP16 representation, and the most significant bit (MSB), bit 15 is at the left end of the FP16 representation. The FP16 representation includes a sign bit, bit 15 410. A sign bit equal to zero can represent a positive number, and a sign bit equal to one can represent a negative number. The FP16 representation further includes a five-bit exponent 412 that is stored in bits bit 10 to bit 14. The FP16 representation further includes a 10-bit mantissa 414 that is stored in bits bit 0 to bit 9. The mantissa can represent a fraction. The FP16 representation can therefore represent positive numbers and negative numbers. In embodiments, the plurality of binary inputs comprises all possible values of the FP16 format number. That is, the binary values stored within the fields of the FP16 representation can represent decimal values 416, ranging between −65,504 and +65,504. When a greater range of decimal values is required for one or more processing tasks, the other floating-point representations, such as single-precision FP32, double-precision FP64, etc. can be used.

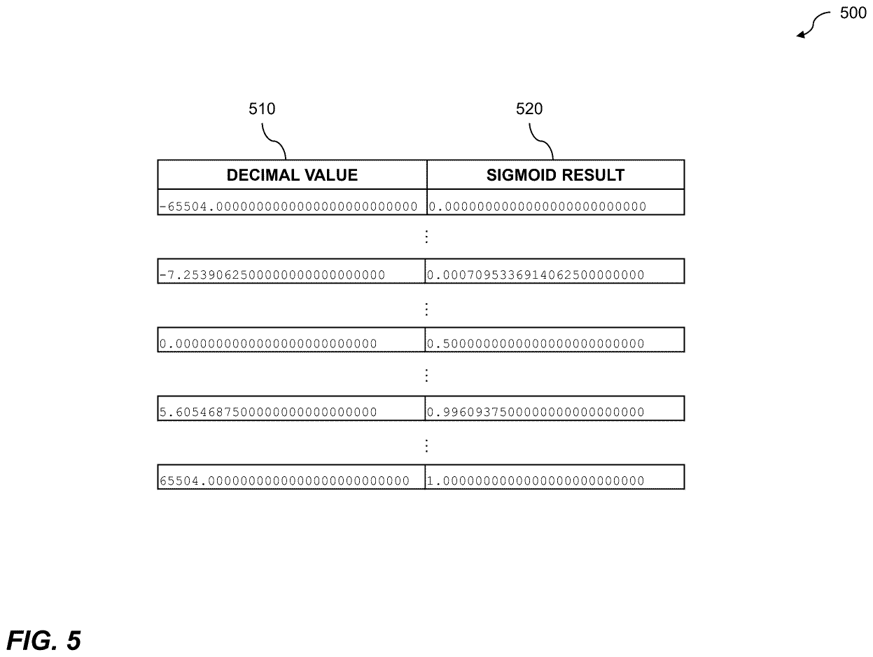

FIG. 5 is a sigmoid lookup table example. An activation function associated with node within a network such as a neural network can be used to determine whether a neuron should be activated. The network can include one or more activation functions. The activation function can further be used to transform one or more inputs to the neuron into an output. Discussed previously and throughout, there are several activation function options available from which to choose. The one or more activation functions can include a hyperbolic tangent (tanh) function, a sigmoid linear unit (SILU), a Swish Gated Linear Unit function (SwiGLU), an Exponential Linier Unit (ELU), a Scaled Exponential Linear Unit (SELU), a Gaussian Cumulative Distribution Function (GELU), and so on. In embodiments, the core activation function is based on a sigmoid function. The choice of activation function can be based on processing tasks such as image processing tasks, processing requirements such as storage requirements and processing speed requirements, and so on. The activation function can be transformed with an instruction set architecture (ISA) extension.

A sigmoid function can describe a mathematical function that, when plotted, yields an S-shaped curve. The S-shaped curve is also described as a sigmoid curve. An example sigmoid function can include:

$$sigmoid ( x ) = 1 / 1 + {e}^{- x} \qquad Equation 2$$

The sigmoid function can produce results between zero and one. The value of sigmoid(x) can be calculated for a range of values such as decimal values. Recall that an FP16 half-precision numbering representation can represent decimal values ranging between −65,504 and +65,504. The sigmoid function values can be calculated using software functions, a plurality of combinational logical functions, and so on. The results of the calculations can be stored in a sigmoid lookup table 500. The lookup table 500 includes decimal values 510 and the sigmoid function calculation results 520 for the decimal values. The lookup table can store calculated results. The LUT can be converted into a binary format before being transformed into a plurality of logical functions. In embodiments, the transforming includes interpolating linearly one or more combinational logic functions within the plurality of combinational logic functions associated with each input bit within the plurality of binary inputs. In embodiments, the interpolating linearly is based on a quantization of four.

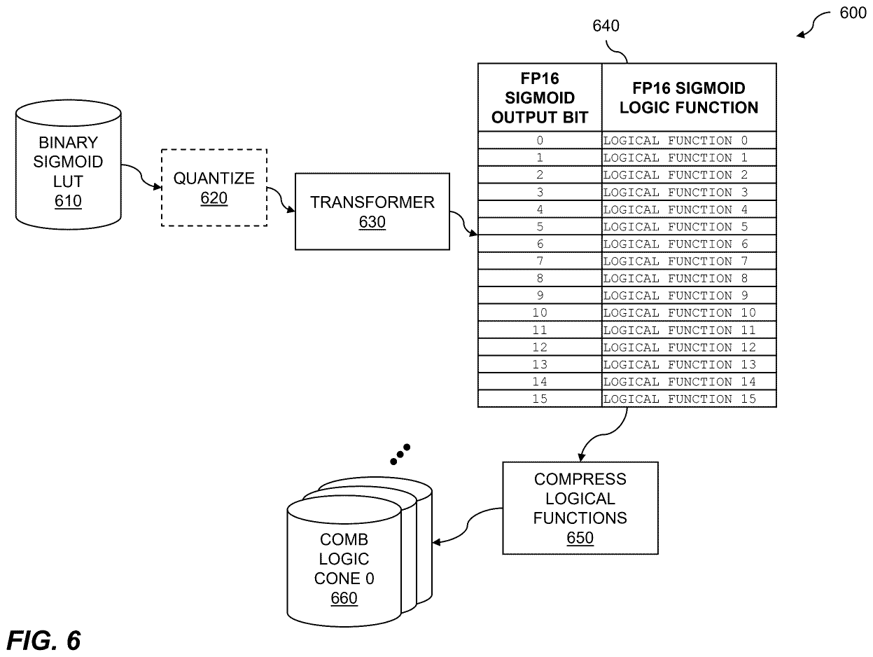

FIG. 6 is an example of creating sigmoid combinational logic functions. Described previously and throughout, a binary output is assigned, in a lookup table (LUT), to each binary input within a plurality of binary inputs, wherein the assigning is based on a core activation function. Further recall that the LUT is transformed, wherein the transforming results in a plurality of combinational logical functions, wherein each combinational logical function within the plurality of combinational logical functions corresponds to a unique output bit of the core activation function. Each combinational logical function can be optimized, reduced, and so on. In embodiments, the transforming includes compressing one or more combinational logic functions within the plurality of combinational logic functions. The one or more compressed combinational logic functions can be stored as “cones,” where a cone can include a piece or block of code written in a language such as a hardware description language (HDL). The HDL can include Verilog®, VHDL, and so on. The cones can be used to generate combinational logic that can determine an output binary value based on each binary input within the plurality of binary inputs. The combinational logic functions enable a transformed activation function with an ISA extension.

The example 600 shows the creation of sigmoid combinational logic functions. A sigmoid lookup table (LUT) 610 is accessed. The LUT can be in a binary format and can stem from a LUT which was in a decimal format. The sigmoid LUT can include a sigmoid value calculated for each input value within a range of values. The range of input values can be based on a numerical representation such as floating-point 16 (FP16). In a usage example, the input values are based on an FP16 numbering representation and can range between decimal values including −65,504 and +65,504. Note that calculating and storing a sigmoid function result for every one of the 131,008 values in the range of decimal values can require a large LUT. Values obtained from the LUT can be quantized 620. The quantizing can be associated with transforming the LUT. The FIG. 600 includes a transformer 630. The transformer transforms the LUT, wherein the transforming results in a plurality of combinational logical functions, wherein each combinational logical function within the plurality of combinational logical functions corresponds to a unique output bit of the core activation function. Discussed previously and throughout, an activation function can be calculated using processor functions such as vector functions, looked up on a table, determined by accessing a library of functions such as vector functions, evaluated using combinational digital logic functions, etc. The combinational logical functions, which determine a core activation function related to the activation function, can evaluate activation function values far faster than can processor function execution or a call to a library. The plurality of combinational logic functions can require substantial hardware to support the functions. Embodiments include interpolating linearly one or more combinational logic functions within the plurality of combinational logic functions associated with each input bit within the plurality of binary inputs. The interpolating can be used to reduce logic function size. Various techniques can be used for the interpolating. In embodiments, the interpolating linearly is based on a quantization of four. The logical functions associated with each sigmoid output bit, resulting from the transforming, can be stored in a table 640.

The logical functions that result from the transforming can be compressed 650. In embodiments, the transforming includes compressing one or more combinational logic functions within the plurality of combinational logic functions. Compressing a combinational logical function can include speeding evaluation by the logical function by identifying and eliminating redundancies in the logical function. The compressing can further include reducing the number of operations (e.g., logical operations) that occur within the logical function. The compressed logical functions can be stored as combinational logic cones 660. A combinational logic cone can describe a group of interconnected logic elements such as gates. An output of the logic cone is determined based on a set of inputs at a given time. The output of the logic cone can be provided to an output such as a primary output of logic, provided to a storage element such as a register, and so on. The logic cone includes no storage elements. Thus, the output value of the logic cone is dependent solely on the current set of input values to the logic cone.

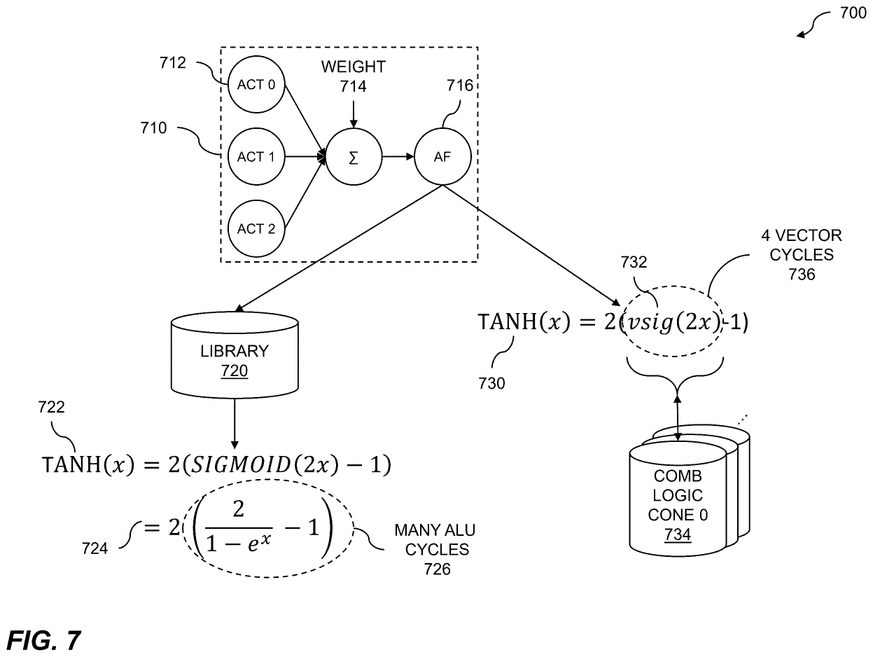

FIG. 7 is an example of accelerating a tanh activation function. The number of computations that are performed to calculate a value for a function such as an activation function can be significant. Since the operations themselves can be computationally intensive, such as performing a series of vector operations or matrix operations using an arithmetic logic unit (ALU) associated with a processor, operations can require a significant number of cycles to complete. Similarly, performing the operations by calling a library of functions such as the vector functions or matrix functions can also require many cycles. By adding a custom instruction to an instruction set architecture (ISA), significant processing acceleration can be achieved. The custom ISA instruction can be used to perform operations associated with activation functions, such as a tanh activation function. Tanh activation function acceleration is enabled by a transformed activation function with an ISA extension.

The example 700 shows an example network node such as a neuron within a neural network. The neuron 710 can receive one or more inputs. The one or more inputs can include primary inputs to the neural network, outputs from a previous or “upstream” layer of neurons within the neural network, and so on. An output from a neuron in a previous layer of the neural network can include the result of an activation function. The inputs to the example neuron include ACT 0 712, ACT 1, and ACT 2. The one or more inputs are multiplied by one or more weights 714. The products of the one or more inputs are added together (sum of products). The sum of products is operated on by an activation function (AF) 716 to generate an output from the neuron. The neural network can include one or more activation functions. In embodiments, the one or more activation functions comprise a hyperbolic tangent (tanh) function. The tanh can be computed by accessing a library of functions 720. Note that the tanh activation function can be computed based on a sigmoid function 722, which can be accelerated with disclosed techniques. The sigmoid function can be expanded 724 and can be computed using one or more operations that can be performed by an arithmetic logic unit (ALU). Note that the sigmoid function can be inefficiently calculated by an ALU unit since an ALU is typically designed to perform basic arithmetic operations such as addition, subtraction, multiplication, and division; and basic logical operations such as AND, OR, NAND, NOR, XOR, XNOR, NOT and so on. As a result, the computation of the tanh function requires many ALU cycles 726. Alternatively, a library can be called to determine the tanh function. However, that can also result in many processor cycles.

Recall that an instruction set architecture (ISA), such as a RISC-V® ISA, can be augmented, wherein the augmenting includes a custom instruction, wherein the custom instruction is based on the plurality of combinational logical functions. The custom instruction can include a custom vector instruction. In embodiments, the custom vector instruction comprises a vsig instruction. As a result, the tanh instruction can be written 730 to use the custom vsig instruction 732. Recall that a plurality of plurality of combinational logical functions can result from transforming a lookup table (LUT). The LUT results from assigning a binary output to each binary input based on a core activation function. The combinational logic functions can include cones of logic 734 that are based on a group of interconnected logic elements such as gates. Thus, the activation function can be programmed. Further embodiments include programming the one or more activation functions for the machine learning model, wherein the programming includes the vsig instruction. By including a vsig instruction in the programming of the activation function, tanh can be computed in four vector cycles 736.

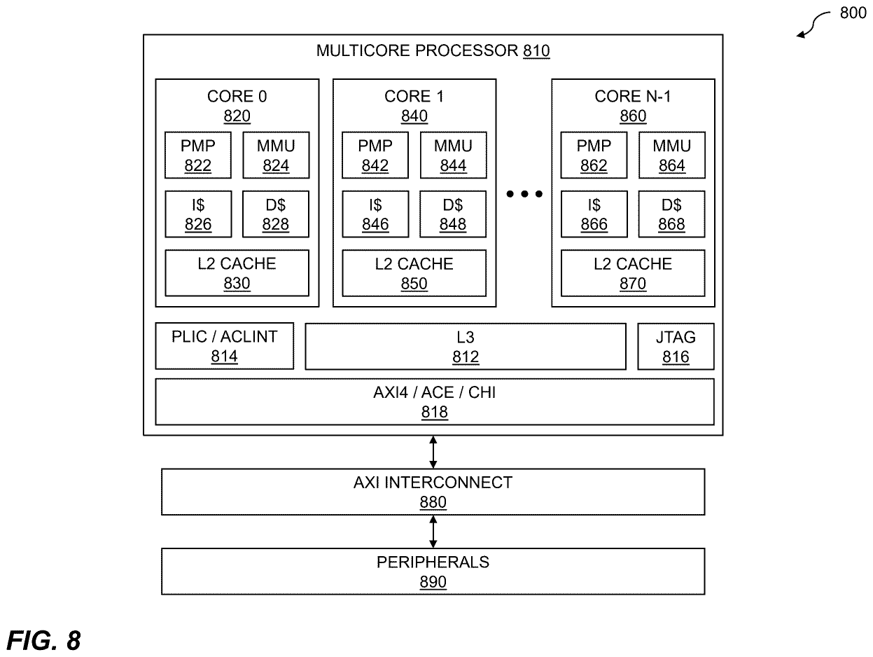

FIG. 8 is a block diagram of a multicore processor. The processor, such as a RISC-V® processor, an ARM processor, or other suitable processor type, can include a variety of elements. The elements can include processor cores including multiprocessor cores, one or more caches including local caches and shared caches, memory protection and management units, local storage, and so on. In one or more exemplary implementations, the processor core enables a transformed activation function with ISA extension. The elements of the multicore processor can further include one or more of a private cache; a test interface such as a joint test action group (JTAG) test interface; one or more interfaces to a network such as a network-on-chip, shared memory, and peripherals; and the like. A binary output is assigned, in a lookup table (LUT), to each binary input within a plurality of binary inputs, wherein the assigning is based on a core activation function. The LUT is transformed, wherein the transforming results in a plurality of combinational logical functions, wherein each combinational logical function within the plurality of combinational logical functions corresponds to a unique output bit of the core activation function. An instruction set architecture (ISA) is augmented, wherein the augmenting includes a custom instruction. The custom instruction is executed, wherein the executing includes accessing, for every output bit of an activation function within the machine learning model, a corresponding combinational logic function with the plurality of combinational logic functions.

In the block diagram 800, the multicore processor 810 can comprise two or more processors, where the two or more processors can include homogeneous processors, heterogeneous processors, etc. In the block diagram, the multicore processor can include N processor cores such as core 0 820, core 1 840, core N−1 860, and so on. Each processor can comprise one or more elements. In one or more implementations, each core, including cores 0 through core N−1, can include a physical memory protection (PMP) element, such as PMP 822 for core 0; PMP 842 for core 1, and PMP 862 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 824 for core 0, MMU 844 for core 1, and MMU 864 for core N−1. The memory management units can translate virtual addresses used by software running on the cores to physical memory addresses with caches, the shared memory system, etc.

The processor cores associated with the multicore processor 810 can include caches such as instruction caches and data caches. The caches, which can comprise level 1 (L1) caches, can include an amount of storage such as 16 KB, 32 KB, and so on. The caches can include an instruction cache I$ 826 and a data cache D$ 828 associated with core 0; an instruction cache I$ 846 and a data cache D$ 848 associated with core 1; and an instruction cache I$ 866 and a data cache D$ 868 associated with core N−1. In addition to the level 1 instruction and data caches, each core can include a level 2 (L2) cache. The level 2 caches can include L2 cache 830 associated with core 0; L2 cache 850 associated with core 1; and L2 cache 870 associated with core N−1. The cores associated with the multicore processor 810 can include further components or elements. The further elements can include a level 3 (L3) cache 812. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 814. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 816. The JTAG can provide a boundary within the cores of the multicore processor. The JTAG can enable fault information to a high precision. The high-precision fault information can be critical to rapid fault detection and repair.

The multicore processor 810 can include one or more interface elements 818. The interface elements can support standard processor interfaces including an Advanced extensible Interface (AXI®) such as AXI4®, an ARM® Advanced extensible Interface (AXI®) Coherence Extensions (ACE®) interface, an Advanced Microcontroller Bus Architecture (AMBA®) Coherence Hub Interface (CHI®), etc. In the block diagram 800, the interface elements can be coupled to the interconnect. The interconnect can include a bus, a network, and so on. The interconnect can include an AXI® interconnect 880. In one or more implementations, the network can include network-on-chip functionality. The AXI® interconnect can be used to connect memory-mapped “master” or boss devices to one or more “slave” or worker devices. In the block diagram 800, the AXI interconnect can provide connectivity between the multicore processor 810 and one or more peripherals 890. The one or more peripherals can include storage devices, networking devices, and so on. The peripherals can enable communication using the AXI® interconnect by supporting standards such as AMBA® Version 4, among other standards.

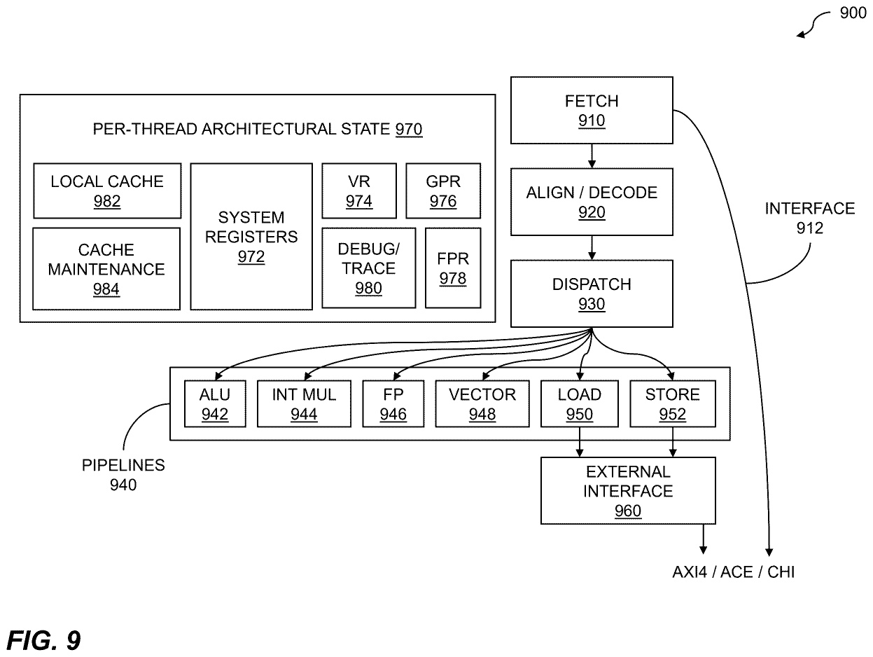

FIG. 9 is a block diagram of a pipeline. One or more pipelines associated with a processor architecture can be used to greatly enhance processing throughput. The processor architecture can be associated with one or more processor cores. Increased processing throughput can be accomplished because multiple operations can be executed in parallel. The increased processing throughput is supported by a transformed activation function with ISA extension. In one or more implementations, a binary output is assigned, in a lookup table (LUT), to each binary input within a plurality of binary inputs. The assigning is based on a core activation function. The LUT is transformed. The transforming results in a plurality of combinational logical functions. Each combinational logical function within the plurality of combinational logical functions corresponds to a unique output bit of the core activation function. An instruction set architecture (ISA) is augmented. The augmenting includes a custom instruction. The custom instruction is executed. The executing includes accessing, for every output bit of an activation function within the machine learning model, a corresponding combinational logic function with the plurality of combinational logic functions.

The blocks within the block diagram can be configurable in order to provide varying processing levels. The varying processing levels can be based on processing speed, bit lengths, word lengths, numbers of micro-operations, and so on. The block diagram 900 can include a fetch block 910. The fetch block 910 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 912. The interface can include a standard interface such as one or more industry standard interfaces. The interfaces can include an Advanced extensible Interface (AXI®), an ARM® Advanced extensible Interface (AXI®) Coherence Extensions (ACE®) interface, an Advanced Microcontroller Bus Architecture (AMBA®) Coherence Hub Interface (CHI®), etc.

The block diagram 900 includes an align and decode block 920. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 900 can include a dispatch block 930. The dispatch block can receive decoded instruction packets from the align and decode block. The decoded instruction packets can be used to control a pipeline 940, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 942, integer multiplier pipelines 944, floating-point unit (FPU) pipelines 946, vector unit (VU) pipelines 948, and so on. The dispatch unit can further dispatch instructions to pipelines that can include load pipelines 950, and store pipelines 952. The load pipelines and the store pipelines can access storage such as the common memory using an external interface 960. The external interface can be based on one or more interface standards such as the Advanced extensible Interface (AXI®). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 970. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 972. The system registers can be associated with individual processors, a system comprising multiple processors, and so on. The system registers can include exception and interrupt components, counters, etc. The per-thread architectural state can include further registers such as vector registers (VRs) 974. The vector registers can be grouped in a vector register file and can be used for vector operations. In one or more exemplary implementations, the width of the vector register file is 912 bits. Additional registers, such as general-purpose registers (GPRs) 976 and floating-point registers (FPRs) 978, can be included. These registers can be used for general-purpose (e.g., integer) operations, and floating-point operations, respectively. The per-thread architectural state can include a debug and trace block 980. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 982. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 984. The cache maintenance state can include maintenance needed, maintenance pending, and maintenance complete states, etc.

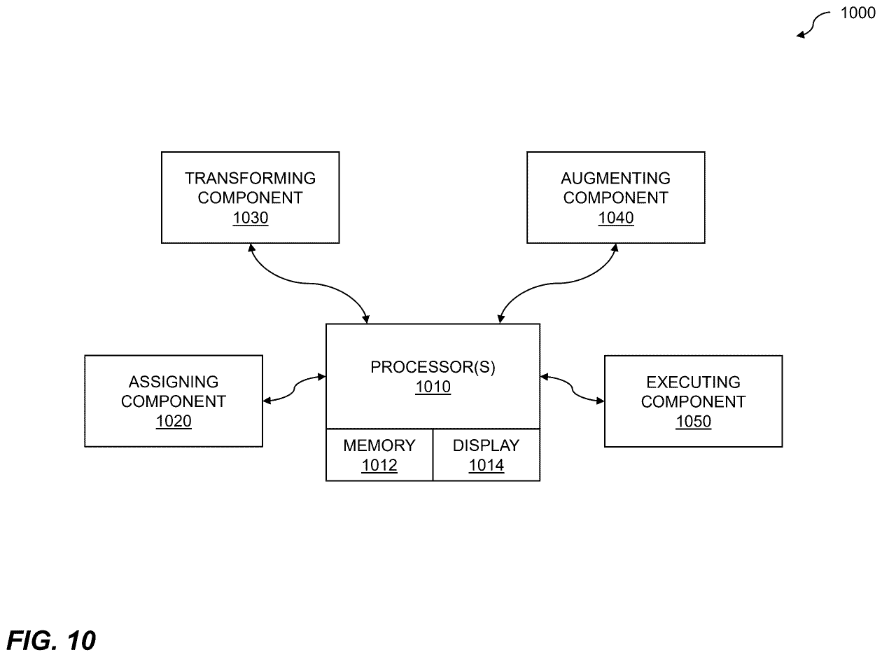

FIG. 10 is a system diagram for activation function execution with custom instruction set architecture (ISA) instructions. The system 1000 can include instructions and/or functions for design and implementation of integrated circuits that support matrix processing in further support of a transformed activation function with an ISA extension. The system 1000 can include instructions and/or functions for generation and/or manipulation of design data such as hardware description language (HDL) constructs for specifying structure and operation of an integrated circuit. The system 1000 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 1000 can include one or more processors 1010. The processors can include standalone processors, processors within integrated circuits or chips, processor cores in FPGAs or ASICs, and so on. The one or more processors 1010 are coupled to a memory 1012, which stores instructions. The memory can include one or more of local memory, cache memory, system memory, etc. The system 1000 can further include a display 1014 coupled to the one or more processors 1010. The display 1014 can be used for displaying data, instructions, operations, micro-operations, and the like. The operations can include instructions and functions for implementation of integrated circuits, including processor cores. In exemplary implementations, the processor cores can include RISC-V® processor cores. A system comprising the one or more processors 1010, when executing the instructions which are stored in the memory 1012, is configured to enable non-blocking unit stride vector instruction dispatch with micro-operations.

The system 1000 can include an assigning component 1020. The assigning component 1020 can include functions and instructions for assigning, in a lookup table (LUT), to each binary input within a plurality of binary inputs, a binary output, wherein the assigning is based on a core activation function. The LUT can include a table stored in a memory or other storage element. The memory can include a local memory, a cache memory, a shared cache memory, a hierarchical cache memory, a memory system, and so on. The LUT can be accessible by a processor such as a processor core. The processor core can include an ARM core, a MIPS core, and/or other suitable core type. In one or more exemplary implementations, the processor core can include a RISC-V architecture. The processor core can support vector operations. The RISC-V architecture can include extensions, where the extensions can enable execution of various arithmetic and logic operations. In exemplary implementations, a RISC-V architecture can include vector extensions. In exemplary implementations, the vector extensions can include ELEN, VLEN, SEW, LMUL, VLMAX, VL, and VSTART components.

Recall that a machine learning (ML) model can comprise a plurality of layers, where the layers can include one or more of an input layer, a hidden layer, an output layer, and so on. Each layer can include one or more neurons, or nodes, where a neuron can receive one or more activations, can perform a summation on the activations, and can produce an output activation. A neuron within a hidden layer, for example, can receive an activation from a one or more neurons in a previous layer. In a usage example, a neuron within a hidden layer can be “fully connected,” where the neuron receives an activation from each neuron in the previous layer. Each activation that is received can be weighted. Thus, each input, such as a binary input, can be assigned a binary output. The effect of a given input on a given output may be zero (e.g., no effect) or may be nonzero (e.g., some effect).

The system 1000 can include a transforming component 1030. The transforming component 1030 can include functions and instructions for transforming the LUT, wherein the transforming results in a plurality of combinational logical functions, wherein each combinational logical function within the plurality of combinational logical functions corresponds to a unique output bit of the core activation function. The plurality of combinational logical functions can be used to synthesize digital logic hardware. The plurality of combinational logical functions can be minimized, optimized, and so on using one or more digital logic design tools. In embodiments, the transforming includes compressing one or more combinational logic functions within the plurality of combinational logic functions. The number of bits that can be included in the plurality of output bits can be based on a standard such as a floating-point standard. The number of bits that comprise the plurality of output bits can be based on a number of bits associated with each binary input to the machine learning model. In embodiments, each binary input within the plurality of binary inputs comprises a floating-point 16 (FP16) format number. Other floating-point format standards such as IEEE Standard 754-2008 (binary16), bfloat16, and so on can be used.

The size of the LUT can become large when all combinational logic functions within a plurality of combinational logic functions are associated with each input bit within the plurality of binary inputs. Since the differences between combinational logic functions can be small, some combinational logic functions can be omitted, relying instead on interpolation. In embodiments, the transforming includes interpolating linearly one or more combinational logic functions within the plurality of combinational logic functions associated with each input bit within the plurality of binary inputs. Other interpolation techniques can be used, such as polynomial interpolation, inverse distances interpolation, spline interpolation, cubic spline interpolation, etc. The linear interpellation can be based on a quantization. In embodiments, the interpolating linearly is based on a quantization of four.

The system 1000 can include an augmenting component 1040. The augmenting component 1040 can include functions and instructions for augmenting an instruction set architecture (ISA), wherein the augmenting includes a custom instruction, wherein the custom instruction is based on the plurality of combinational logical functions. The custom instruction can include a function, such as a core activation function, that pertains to processing an activation function. In embodiments, the custom instruction comprises a custom vector instruction. The custom instruction can include a custom matrix instruction, a custom function instruction such as a hyperbolic tangent instruction, and so on. The ISA can be associated with a specific processor instruction set. In embodiments, the ISA comprises a RISC-V® ISA. The ISA can be based on instruction inherent to the processor architecture, one or more states associated with the processor, and the like. In embodiments, the custom instruction is based on one or more RISC-V® vector state variables. The custom instruction can be used to enhance computations associated with a core activation function. More than one activation function can be supported by the custom instruction. In embodiments, the core activation function is based on a sigmoid function. The custom instruction can include one or more functions, operations, instructions, etc., associated with the processor architecture. In embodiments, the custom vector instruction comprises a vsig instruction. The vsig instruction includes a “vector signature” instruction. In other embodiments, the custom vector instruction comprises a vexp instruction.

Discussed previously and throughout, a binary output is assigned in a lookup table to each binary input within a plurality of binary inputs. The assigning is based on a core activation function which can be associated with one or more activation functions that can be used by a machine learning model. A variety of techniques can be used to realize the core activation function. Embodiments include programming the one or more activation functions for the machine learning model, wherein the programming includes the vsig instruction. The programming can be based on instructions associated with a processor core, one or more custom instructions, and so on. In embodiments, the programming includes one or more additional ISA instructions, wherein the one or more additional ISA instructions complete the one or more activation functions. The activation functions can include the sigmoid function described above or another activation function. In embodiments, the one or more activation functions comprise a hyperbolic tangent (tanh) function. The tanh function can be based on the sigmoid function, a vsig function, etc. In embodiments, the one or more activation functions comprises a sigmoid linear unit function (SILU). The SILU, which can also be referred to as a “Swish” activation function, can be calculated by multiplying an input value by a result of applying the sigmoid function to the input value. In other embodiments, the one or more activation functions comprise a Swish Gated Linear Unit function (SwiGLU). The SwiGLU can be computed by combining a SILU activation function with a Gated Linear Unit (GLU). The GLU can enable control of data through a neural network by selectively permitting or “gating” relevant data to flow through a neural network while filtering out irrelevant data. In further embodiments, the core activation function is based on an exponential function (EXP). In a usage example, an exponential function can be used to compute a hyperbolic tangent value.

Further activation functions can be used. In embodiments, the one or more activation functions comprise an Exponential Linear Unit (ELU). An ELU differs from another activation function, the rectified linear unit (ReLU), in that the ReLU provides only positive values while the ELU provides both positive and negative values. The ReLU outputs zero for negative values. In embodiments, the one or more activation functions comprise a Scaled Exponential Linear Unit (SELU). The SELU differs from the ELU in that the SELU can normalize an output from a layer within a machine learning (ML) model network. The normalization can prevent vanishing gradients (small) and exploding gradients (large). The control of the gradients can maintain a stable distribution of activations throughout a network.

The system 1000 can include an executing component 1050. The executing component 1050 can include functions and instructions for executing one or more activation functions within a machine learning model, wherein the executing is based on the custom instruction. In embodiments, the executing includes accessing, for every output bit of an activation function within the machine learning model, a corresponding combinational logic function within the plurality of combinational logic functions. The executing can include executing one or more software instructions, where the software instructions include the custom instruction. The custom instruction can include a custom vector instruction. Recall that the custom instruction can be based on an instruction set architecture associated with a processor architecture. In embodiments, the ISA comprises a RISC-V ISA. The custom instruction can include a custom vector instruction. In embodiments, the custom vector instruction comprises a vsig instruction. The custom instruction can further be executed in a processor emulator. The custom instruction can also be executed in hardware, where the hardware includes hardware associated with the plurality of combinational logic functions.

The system 1000 can include a computer program product embodied in a non-transitory computer readable medium for matric processing, the computer program product comprising code which causes one or more processors to generate semiconductor logic for: assigning, in a lookup table (LUT), to each binary input within a plurality of binary inputs, a binary output, wherein the assigning is based on a core activation function; transforming the LUT, wherein the transforming results in a plurality of combinational logical functions, wherein each combinational logical function within the plurality of combinational logical functions corresponds to a unique output bit of the core activation function; augmenting an instruction set architecture (ISA), wherein the augmenting includes a custom instruction, wherein the custom instruction is based on the plurality of combinational logical functions; and executing one or more activation functions within a machine learning model, wherein the executing is based on the custom instruction.

The system 1000 can include a computer system for matrix processing comprising: a memory which stores instructions; one or more processors coupled to the memory wherein the one or more processors, when executing the instructions which are stored, are configured to: assign, in a lookup table (LUT), to each binary input within a plurality of binary inputs, a binary output, wherein the assigning is based on a core activation function; transform the LUT, wherein the transforming results in a plurality of combinational logical functions, wherein each combinational logical function within the plurality of combinational logical functions corresponds to a unique output bit of the core activation function; augment an instruction set architecture (ISA), wherein the augmenting includes a custom instruction, wherein the custom instruction is based on the plurality of combinational logical functions; and execute one or more activation functions within a machine learning model, wherein the executing is based on the custom instruction.

As can now be appreciated, exemplary implementations can improve processor performance for matrix processing by executing a custom instruction, where the custom instruction augments an instruction set architecture (ISA). The custom instruction executes based on a plurality of combinational logic functions, where the combinational logic functions are transformed from a lookup table (LUT). Within the LUT, a binary output is assigned to each binary input within a plurality of binary inputs. The assigning is based on a core activation function. The core activation function can include a sigmoid function, a hyperbolic tangent (tanh) function, a sigmoid linear unit (SILU) function, a Swish Gated Linear Unit (SwiGLU) function, and so on. The custom instruction therefore executes in hardware, rather than relying on function calls to a software library. Thus, the custom instruction is able to perform operations based on activation functions executing in hardware faster than is possible with calls to software functions. In this way, exemplary implementations can enable fast execution of activation functions that form the bases of complex machine learning (ML) models.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for matrix processing comprising:
assigning, in a lookup table (LUT), to each binary input within a plurality of binary inputs, a binary output, wherein the assigning is based on a core activation function;
transforming the LUT, wherein the transforming results in a plurality of combinational logical functions, wherein each combinational logical function within the plurality of combinational logical functions corresponds to a unique output bit of the core activation function;
augmenting an instruction set architecture (ISA), wherein the augmenting includes a custom instruction, wherein the custom instruction is based on the plurality of combinational logical functions; and
executing one or more activation functions within a machine learning model, wherein the executing is based on the custom instruction.

2. The method of claim 1 wherein the executing includes accessing, for every output bit of an activation function within the machine learning model, a corresponding combinational logic function within the plurality of combinational logic functions.

3. The method of claim 1 wherein the custom instruction comprises a custom vector instruction.

4. The method of claim 3 wherein the ISA comprises a RISC-V® ISA.

5. The method of claim 4 wherein the custom instruction is based on one or more RISC-V vector state variables.

6. The method of claim 3 wherein the core activation function is based on a sigmoid function.

7. The method of claim 6 wherein the custom vector instruction comprises a vsig instruction.

8. The method of claim 7 further comprising programming the one or more activation functions for the machine learning model, wherein the programming includes the vsig instruction.

9. The method of claim 8 wherein the programming includes one or more additional ISA instructions, wherein the one or more additional ISA instructions complete the one or more activation functions.

10. The method of claim 8 wherein the one or more activation functions comprise a hyperbolic tangent (tanh) function.

11. The method of claim 8 wherein the one or more activation functions comprise a sigmoid linear unit function (SILU).

12. The method of claim 8 wherein the one or more activation functions comprise a Swish gated linear unit function (SwiGLU).

13. The method of claim 3 wherein the core activation function is based on an exponential function (EXP).

14. The method of claim 13 wherein the custom vector instruction comprises a vexp instruction.

15. The method of claim 14 wherein the one or more activation functions comprise an Exponential Linear Unit (ELU).

16. The method of claim 14 wherein the one or more activation functions comprise a Scaled Exponential Linear Unit (SELU).

17. The method of claim 1 wherein the transforming includes interpolating linearly one or more combinational logic functions within the plurality of combinational logic functions associated with each input bit within the plurality of binary inputs.

18. The method of claim 17 wherein the interpolating linearly is based on a quantization of four.

19. The method of claim 1 wherein the transforming includes compressing one or more combinational logic functions within the plurality of combinational logic functions.

20. The method of claim 1 wherein each binary input within the plurality of binary inputs comprises a floating-point 16 (FP16) format number.

21. The method of claim 20 wherein the plurality of binary inputs comprises all possible values of the FP16 format number.

22. The method of claim 1 wherein the core activation function and the one or more activation functions comprise a Gaussian cumulative distribution function (GELU).

23. A computer program product embodied in a non-transitory computer readable medium for matrix processing, the computer program product comprising code which causes one or more processors to generate semiconductor logic for:
assigning, in a lookup table (LUT), to each binary input within a plurality of binary inputs, a binary output, wherein the assigning is based on a core activation function;
transforming the LUT, wherein the transforming results in a plurality of combinational logical functions, wherein each combinational logical function within the plurality of combinational logical functions corresponds to a unique output bit of the core activation function;
augmenting an instruction set architecture (ISA), wherein the augmenting includes a custom instruction, wherein the custom instruction is based on the plurality of combinational logical functions; and
executing one or more activation functions within a machine learning model, wherein the executing is based on the custom instruction.

24. A computer system for matrix processing comprising:
a memory which stores instructions;
one or more processors coupled to the memory, wherein the one or more processors, when executing the instructions which are stored, are configured to:
assign, in a lookup table (LUT), to each binary input within a plurality of binary inputs, a binary output, wherein the assigning is based on a core activation function;
transform the LUT, wherein the transforming results in a plurality of combinational logical functions, wherein each combinational logical function within the plurality of combinational logical functions corresponds to a unique output bit of the core activation function;
augment an instruction set architecture (ISA), wherein the augmenting includes a custom instruction, wherein the custom instruction is based on the plurality of combinational logical functions; and
execute one or more activation functions within a machine learning model, wherein the executing is based on the custom instruction.
